(19) United States
(12) Patent Application Publication
(10) Pub. No.: US 2012/0308072 A1
(43) Pub. Date: Dec. 6, 2012

(54) PRINTED DEVICE WITH THREE-DIMENSIONAL APPEARANCE

(75) Inventors: Olivier LEFÈBVRE, Lausanne (CH); Pierre DEGOTT, Crissier (CH); Raynald DEMANGE, Montagny-pres-Yverdon (CH); Nicolas PIETROLUNGO, Bossonnens (CH)

(73) Assignee: SICPA HOLDING SA, Prilly (CH)

(21) Appl. No.: 13/397,069

(22) Filed: Feb. 15, 2012

Related U.S. Application Data
(60) Provisional application No. 61/491,734, filed on May 31, 2011.

(30) Foreign Application Priority Data
May 31, 2011 (EP) 11168298.5

(51) Int. Cl. G06K 9/00

(52) U.S. Cl. 382/100

(57) ABSTRACT

The present invention is related to a device useful as a security element comprising first and second LC ink layers representing a graphical object exhibiting, when observed with an appropriate viewing equipment, a three-dimensional appearance, wherein one of said ink layers shows a first color at a certain viewing angle and is a left-handed circularly polarizing coating or comprises left-handed circularly polarizing pigment, and the other of said ink layers shows the same or another color at said viewing angle and is a right-handed circularly polarizing coating or comprises right-handed circularly polarizing pigment, said first and second LC ink layers representing a first and a second image corresponding to a pair of stereoscopic projections of said object, characterized in that said first and second images are composed of separate building blocks which are superimposed or can be superimposed.

### CROSS-REFERENCE TO RELATED APPLICATIONS

The present application claims the benefit under 35 U.S.C. §119(e) of U.S. Provisional Application No. 61/491,734, filed May 31, 2011 and claims priority under 35 U.S.C. §119 of EP 11168298.5, filed May 31, 2011. The entire disclosures of these applications are expressly incorporated by reference herein.

### BACKGROUND OF THE INVENTION

1. Field of the Invention

The present invention relates generally to the field of devices useful as security elements for the protection of banknotes and documents of value or articles and specifically to a device and a method for producing printed devices useful as security elements with three-dimensional appearance when viewed with an appropriate optical viewing equipment, such as eyeglasses with lenses acting as circularly polarizing filters. The printed device is formed with stereoscopic images of the object, the latter being composed of separate building blocks.

2. Discussion of Background Information

Three-dimensional representations of objects composed of images formed by pairs of stereoscopic projections are known in the art.

U.S. Pat. Nos. 5,457,554 and 5,364,557, the entire disclosures of which are incorporated by reference herein, disclose a method for producing three-dimensional images made of ink layers comprising cholesteric liquid crystals materials, said ink layers reflecting right-handed (RHLC ink layer) or, respectively, left-handed (LHLC ink layer) circularly polarized light. In order to produce said three-dimensional images, LC ink layers of different primary colors are printed on top of each other.

U.S. Pat. No. 7,041,233, the entire disclosure of which is incorporated by reference herein, describes a method for generating a three-dimensional effect with 2 non-stereoscopic images formed with chiral liquid crystal (also called cholesteric liquid crystal) material. The liquid crystal layers are aligned by a thermal process or are used preferably in an encapsulated form. The three-dimensional effect produced by this technology can be seen from large distance such as at least 5 meters. The formation of different color areas required the use of a mask during the LC curing process (e.g. example 1).

Industrial printing of devices useful as security elements with printing technologies such as silkscreen, flexogravure or rotogravure must comply with some limitations that were not addressed by the above disclosed technologies for generating three-dimensional effects. For instance, with these printing technologies, 2 printing units are required to print the left-handed liquid crystal (LHLC) and the right-handed liquid crystal (RHLC) ink layers of a pair of stereoscopic projections; both printing units may print a LC ink layer of the same color at a certain viewing angle, or the two printing units may print a pair of LC ink layers of different color at the same viewing angle resulting in an additive color for the 3-D image. The number of printing units available to print a device is generally restricted to 2 units or 4 units; hence the number of colors available to print a device with LC inks is very narrow.

3-D perception relies on many parameters that are simultaneously interpreted by the human brain. For real objects or real scenes, the human brain essentially uses the binocular disparity to extract 3-D perception of objects and focal depth information of a scene; the binocular disparity refers to the difference in retinal image location of an object seen by the left and the right eyes. For printed images, the most relevant clues of 3-D shapes are the texture gradient, shades, or the shadows; for scenes comprising a plurality of objects the occlusion of one object by the other (i.e. one object is laid in front of the other and thus hides the underlying object) is an additional important clue of the spatial arrangement of the scene and of the 3-D shape of the objects.

When only a very limited number of mono-color ink layers (e.g. one or two mono-color ink layers) is available, the volume perception fades due to the reduction or disappearance of the 3-D clues such as shades; in the case of scenes comprising a plurality of objects printed with a mono-color ink layer, the occlusion of one object by another one prevents the observer to have a clue as to the relative distance of the different objects.

This effect is exemplified in FIGS. 1 to 4 of the present application. FIG. 1 shows a pair of mono-color stereoscopic projections of a non-subdivided object, a cube, formed by a mono-color layer printed aside each other. FIG. 2 shows said pair of mono-color stereoscopic projections of FIG. 1 printed in a partially superimposed arrangement. The volume or 3-D shape of the cube cannot be recognized, even when printing the FIG. 1 or FIG. 2 with LHLC and RHLC ink layers and using appropriate circularly polarizing filters for observation, because the object lacks any clues from which the human brain could deduce a three-dimensional form of the cube.

FIG. 3 and FIG. 4 illustrate the disappearance of the 3-D effect when using a mono-color layer (FIG. 4) instead of shadow nuances (FIG. 3) for the formation of the object. While in FIG. 3 the details of the human head are apparent and the human brain is able to understand the object as being a three-dimensional image of a human head, the same is not possible with the image in FIG. 4. In FIG. 4, only the contours of the human head are perceivable. The observer's brain cannot interpret FIG. 4 as a three-dimensional image of a human head.

The specific restrictions imposed by industrial printing processes of devices useful as security elements make it impossible to generate three-dimensional effects by any of the above discussed prior art techniques.

Thus, there is still a need for a method for printing a device with a three-dimensional appearance with a very limited number of ink layers reflecting circularly polarized light (LC ink layers).

The disclosed technologies are silent about methods to produce devices with a three-dimensional appearance (3-D devices) useful as security elements, with only two mono-color LC ink layers reflecting light of opposite polarization direction, or with a very restricted number of pairs of mono-color LC ink layers reflecting light of opposite polarization direction.

### SUMMARY OF THE INVENTION

The present invention provides a device that comprises, on at least one substrate or background, first and second ink layers which together represent a graphical object exhibiting, when observed with appropriate viewing equipment, a three-dimensional appearance. One of the first and second ink layers shows a first color at a given viewing angle and is a left-handed circularly polarizing coating or comprises left-handed circularly polarizing pigment and the other one of the first and second ink layers shows a second color at said viewing angle that may be the same or different from the first color and is a right-handed circularly polarizing coating or comprises right-handed circularly polarizing pigment. The first and second ink layers represent a first and a second image of a pair of stereoscopic projections of said graphical object, and said first and second ink layers are superimposed on each other, or are superimposable on each other, or are printed aside each other. The graphical object is composed of two or more separate building blocks, and within each of the stereoscopic projections, the building blocks forming the graphical object are represented such as to let the underlying background of said ink layers be apparent between the building blocks.

The present invention further provides a method for producing a device as defined above, which method comprises applying onto at least on substrate a first ink composition and a second ink composition to form first and second ink layers, one of said ink compositions comprising left-handed circularly polarizing cholesteric liquid crystal pigments having a first color at a certain viewing angle, and the other ink composition comprising right-handed circularly polarizing cholesteric liquid crystal pigments of the same or a different color at said viewing angle, by, e.g., a printing method, preferably a printing method selected from silkscreen printing, flexo printing, heliogravure, and inkjet printing, most preferably by silkscreen printing.

The present invention further provides a method for producing a device according to the present invention as set forth above. The method comprises
a) applying first and second ink compositions onto at least one pre-patterned substrate (e.g., by a printing method, preferably selected from silkscreen printing, flexo printing, heliogravure, and inkjet printing, most preferably by silkscreen printing) to form a first and a second ink layer, one of said ink compositions comprising a left-handed circularly polarizing cholesteric liquid crystal substance having a first color at a certain viewing angle, and the other one of said ink compositions comprising a right-handed circularly polarizing cholesteric liquid crystal substance of the same or a different color at said viewing angle;
b) aligning said layers comprising said cholesteric liquid crystal substances by interaction with the pre-patterned substrate; and
c) curing the layers applied and aligned in a) and b).

The present invention further provides a method for producing a device representing a graphical object exhibiting, when observed with appropriate viewing equipment, a three-dimensional appearance. The method comprises subdividing said graphical object into separate building blocks and generating first and second stereoscopic projections of the subdivided graphical object onto the printing plane.

The present invention further provides an authentication system that comprises a device according to the instant invention as set forth above and viewing equipment, preferably eyeglasses comprising a left and a right circularly polarizing filter for the two lenses, each lens covering one eye of an observer wearing those glasses.

The present invention further provides a method of protecting a commercial good or a security document (e.g., a banknote, a document of value, a credit card, a transportation ticket or card, a tax banderol, or a product label) against counterfeiting. The method comprises providing the good or document with a device according to the instant invention as set forth above.

The present invention provides a method of printing devices useful as security elements exhibiting, when observed with appropriate viewing equipment, a three-dimensional effect, using a first ink comprising chiral liquid crystal pigments or substances, said pigments or substances reflecting left-handed circularly polarized light (LHLC ink layer) and a second ink comprising chiral liquid crystal pigments or substances, said pigments or substances reflecting right-handed circularly polarized light (RHLC ink layer). According to the method of the present invention, the three-dimensional effect can be produced with a very limited number of colors, preferably with LC pigments of up to two different colors at a certain viewing angle, most preferably with LC pigments of a single color at a certain viewing angle.

According to the method of the present invention, the three-dimensional effect is produced by printing a pair of images, each image representing one of a pair of stereoscopic projections, of a graphical object composed of separate building blocks, said graphical object being a representation of a real or of a virtual object. The three-dimensional effect is observable when the observer uses appropriate viewing equipment comprising a pair of circularly polarizing filters or lenses to observe the device of the present invention.

In a further aspect, the present invention provides a method for subdividing a graphical object into separate building blocks.

In a further aspect, the present invention provides a method for creating a pair of stereoscopic projections of a graphical object composed of separate building blocks and printing images representing said pair of stereoscopic projections on a substrate.

Subdividing the graphical object into a plurality of separate building blocks (e.g., at least about 2, at least about 3, at least about 4, at least about 5, at least about 10, at least about 15, or at least about 20 separate building blocks) allows overcoming limitations inherent to the described security features, giving clues to the brain to understand the volume of the represented object or of the represented scene comprising a plurality of objects.

The generation of a 3-dimensional effect based upon the projection of two different perspective images being viewed with the left and the right eye of an observer is known in the art (see, e.g., U.S. Pat. No. 5,457,554 or U.S. Pat. No. 7,041,233). It is known in the art that a pair of stereoscopic projections may be created by capturing with a real camera or with a virtual camera, a pair of images of a real object or of a virtual object, said camera being moved along an axis at a constant distance from the object (FIG. 21a); or alternatively said camera being moved along a path at right angle of the camera shooting direction (FIG. 21b) (the shooting directions of the camera (axis y) towards the object or the scene at both positions are parallel to each other and are perpendicular to the moving path of the camera (x axis)). The pair of first and second stereoscopic projections is obtained by the projection on a plane of the pair of images captured by the camera.

In a preferred aspect of the present invention, the building blocks that belong to the back-side of the graphical object, relative to the observer's position and thus hidden to the observer from his viewing position, are removed. The removal of the hidden building blocks improves the 3-D effect by preventing any occlusion of building blocks. This removal of building blocks can be omitted if the subdivision of the graphical object into building blocks is performed by a direct application of an appropriate set of building blocks onto only the part of the surface of the graphical object which is seen by the observer from his viewing angle.

The first and second LC image layers, corresponding to the first and second stereoscopic projections, may be applied (e.g. printed) upon each other (superimposed LC image layers) or may be laid upon each other (superimposable LC image layers) such as to partially overlap each other; alternatively the first and second LC image layers, corresponding to the first and second stereoscopic projections, may be printed aside each other apart from each other (not superimposed LC image layers).

When printed aside each other, the distance between the two LC ink layers may vary between zero (contiguous position; the two stereoscopic projections are joined to each other by one point or one side) and a few centimetres, preferably about 0-5 cm, more preferably about 0-3 cm and most preferably about 0-1 cm (non-contiguous position). The two non-superimposed LC image layers must be viewable simultaneously by the observer using the viewing equipment in order to view the object with a 3-D appearance. The 3-D effect of the device usually improves with decreasing distance between the two stereoscopic projections. The best 3-D effect usually is obtained when the two stereoscopic projections are printed such as to partially overlap each other.

When the first and second LC image layers corresponding to the first and the second stereoscopic projections are printed a few centimetres apart from each other, the 3-D appearance of the device usually is better perceived when the observer views the device from a distance, e.g. from an arm length or from a larger distance. For each device, there is an optimum observation distance in order to perceive the optimum 3-D effect; when the observation distance is shorter or larger than the optimum distance, the 3-D effect is still perceived but it may be less pronounced. The optimum observation distance depends on the overlapping degree of the LHLC and the RHLC image layers or on the distance between the LHLC and the RHLC image layers arranged aside each other; the optimum observation distance also depends on the dimensions of the virtual triangle defined by the position of the graphical object and both camera positions when shooting the stereoscopic images.

For devices useful as security elements for security documents, banknotes or goods of value the first and second LC image layers are most preferably arranged (printed) to partially overlap each other. When the first and second image layers are applied to partially overlap each other, at least a partial curing of the first LC ink layer is usually required before applying the second LC ink layer.

The device of the instant invention is useful as a security element or as a security feature for the protection of, for example, banknotes, documents of value, identity documents or, in general any article which benefits from authentication.

### BRIEF DESCRIPTION OF THE DRAWINGS

In the accompanying drawings:

FIG. 1 shows a pair of mono-color stereoscopic projections of a cube not subdivided into separate building blocks (not in accordance with the present invention).

FIG. 2 shows a pair of stereoscopic projections of FIG. 1, the projections being placed partially on each other (not in accordance with the present invention).

FIG. 3 shows a picture of a 3-D object (human head) comprising a variation of color lightness (shadow areas) (not in accordance with the present invention).

FIG. 4 shows the picture of FIG. 3 represented with a mono-color ink layer (not in accordance with the present invention).

FIG. 5 shows a view of a device comprising a cube subdivided as shown in FIG. 6, with the superposition of the two LC image layers consisting of the two stereoscopic projections. If the two LC image layers were printed with a pair of LC ink layers on an absorbing underlying surface an observer using an appropriate pair of circularly polarizing filters would see a mono-color cube with a 3-D volume.

FIG. 6 shows the pair of mono-color stereoscopic projections of FIG. 1 of a cube subdivided into 3 separate building blocks.

FIG. 7 shows the graphical object of FIG. 3 subdivided into a plurality of mono-color dots.

FIG. 8 shows a pair of stereoscopic projections of the subdivided object of FIG. 7.

FIG. 8a shows a picture of a device printed with LHLC and RHLC compositions from the pair of stereoscopic projections of FIG. 8. The LHLC and the RHLC layers are printed such as to slightly overlap each other.

FIG. 8b shows a picture of a device printed with LHLC and RHLC compositions from the pair of stereoscopic projections of FIG. 8. The LHLC and the RHLC layers are printed such as to partially overlap each other.

FIG. 9 shows a pair of mono-color stereoscopic projections of a cube subdivided into a plurality of separate building blocks.

FIG. 10 shows a pair of mono-color stereoscopic projections of a sphere subdivided into a plurality of separate building blocks.

FIG. 11a shows a pair of mono-color stereoscopic projections of a cube subdivided into a plurality of separate building blocks, the building blocks being discs.

FIG. 11b shows the pair of mono-color stereoscopic projections of a cube subdivided in a plurality of separate building blocks from FIG. 11a, printed as a negative image.

FIG. 12 shows a pair of mono-color stereoscopic projections of a cube subdivided into a plurality of separate building blocks, the building blocks being dots.

FIG. 13 shows a pair of mono-color stereoscopic projections of a cube subdivided into a plurality of separate building blocks, the building blocks being straight lines.

FIG. 14 shows a pair of mono-color stereoscopic projections of a cube subdivided into a plurality of separate building blocks, the building blocks being the letters “A”.

FIG. 15 shows a side view of a device, e.g. the device of FIG. 5, with partial superposition of the RHLC and LHLC image layers on an absorbing underlying surface, said RHLC and LHLC image layers consisting of the pair of stereoscopic projections. The LHLC and RHLC image layers are superimposed.

FIG. 15a shows a side view of a device, e.g. the device of FIG. 5, with the RHLC and LHLC image layers printed aside each other (not superimposed and contiguous position) on an absorbing underlying surface, said RHLC and LHLC image layers consisting of the pair of stereoscopic projections.

FIG. 15b shows a side view of a device, e.g. the device of FIG. 5, with the RHLC and LHLC image layers printed aside each other (not superimposed and non-contiguous position) on an absorbing underlying surface, said RHLC and LHLC image layers consisting of the pair of stereoscopic projections.

FIG. 16 shows a side view of a device with a first LC image layer printed on an absorbing surface and a second LC image layer printed on a transparent zone of the same substrate, said first and second image layers consisting of the pair of stereoscopic projections. The two LC image layers are superimposable: in order to view the three-dimensional device, the substrate must be folded in such a way that the second LC image layer printed on the transparent zone is laid on top of the first LC image layer. In this configuration, in order to reconstruct correctly the device with the 3-D appearance (3-D device), the two LC layers have to be printed by applying to the second stereoscopic projection a 180° rotation along a symmetry axis, parallel to the folding axis of the substrate.

FIG. 17 shows a side view of a device with a first LC image layer printed on an absorbing surface of a first substrate and the second LC image layer printed on a transparent area of a second substrate, said first and second image layers consisting of the pair of stereoscopic projections. In this configuration, in order to reconstruct correctly the 3-D device, the second image layer (printed on the transparent substrate) must lay on top of the image layer printed on the absorbing surface. The two LC image layers are superimposable.

FIG. 18 shows a side view of a device with the superposition of the RHLC and LHLC image layers printed on a transparent substrate, said RHLC and LHLC image layers consisting of the pair of stereoscopic projections. A further substrate coated with an absorbing layer is required to visualize the LC image layers; the coated substrate is placed under the pair of superimposed LC image layers of the 3-D device. The LC layers are superimposed.

FIG. 19 shows a side view of a device with the RHLC and LHLC image layers printed in different areas of a transparent substrate, said RHLC and LHLC image layers consisting of the pair of stereoscopic projections. The second LC image layer is printed in a reverse orientation according to a symmetry axis parallel to the folding axis of the substrate and the two LC image layers are superimposable (in a similar way as in FIG. 16). A further substrate coated with an absorbing layer is required to visualize the LC image layers; said coated substrate is placed under the pair of superimposed LC image layers, the transparent substrate being folded such as to superimpose the LHLC and RHLC image layers.

FIG. 20 shows a side view of a device with the RHLC and LHLC image layers printed on 2 different transparent substrates, said RHLC and LHLC image layers consisting of the pair of stereoscopic projections. The LC image layers are superimposable. A further substrate coated with an absorbing layer is required to visualize the LC image layers; the coated substrate is placed under the pair of superimposed LC image layers.

FIG. 21a shows a representation of the travel of a camera capturing a pair of images of a graphical object, e.g. a cube, at a constant distance from the object. The pair of stereoscopic projections is obtained by projecting on a 2-dimensional surface the pair of images captured by the camera.

FIG. 21b shows a representation of the travel of a camera capturing a pair of images of a graphical object, e.g. a cube, wherein the camera travels along a path perpendicular to the shooting direction towards the object. The pair of stereoscopic projections is obtained by projecting on a 2-dimensional surface the pair of images captured by the camera.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

According to the present invention, the device representing a graphical object having a three-dimensional appearance when viewed with the appropriate viewing equipment is formed from first and second image layers. The first image layer is applied (e.g. printed) with a LC ink layer reflecting the left-handed polarized light (LHLC ink layer), said LC ink layer comprising at least one left-handed chiral liquid crystal pigment (also called left-handed cholesteric liquid crystal pigment) (LHLC pigments) or left-handed chiral liquid crystal substance (also called left-handed cholesteric liquid crystal substance) (LHLC coating) of a first color at a certain viewing angle, and the second image layer is printed with a LC ink layer reflecting the right-handed polarized light (RHLC ink layer), said LC ink layer comprising at least one right-handed chiral liquid crystal pigment (also called right-handed cholesteric liquid crystal pigment) (RHLC pigments) or right-handed chiral liquid crystal substance (also called right-handed cholesteric liquid crystal substance) (RHLC coating) of the same or of a different color at the same viewing angle. The two image layers are characterized by the fact that they represent a pair of stereoscopic projections of a graphical object and that the graphical object is composed of separate building blocks.

As used herein, the term “LHLC pigments” refers to the LC pigments comprised in the LHLC ink layer, and the term “RHLC pigments” refers to the LC pigments comprised in the RHLC ink layer.

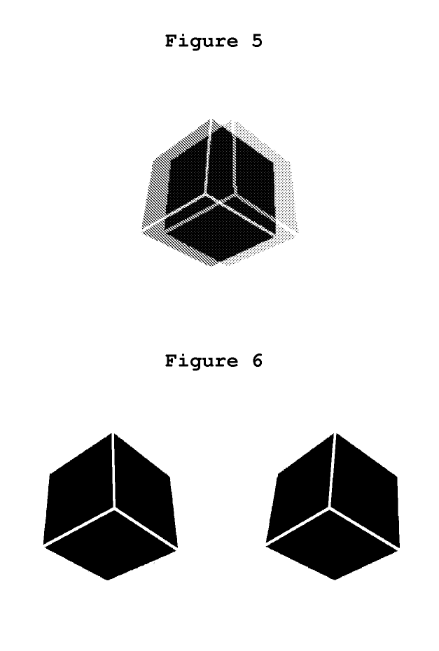

The idea of the present invention is represented in FIG. 5, FIG. 6 and FIGS. 8 to 14. When printed with LHLC and RHLC image layers, FIG. 5, FIG. 6 and FIGS. 8 to 14 represent embodiments of the device of the present invention.

FIG. 5 shows an embodiment of the present invention with the two stereoscopic projections shown in FIG. 6 being printed such as to partially overlap each other.

In FIG. 6 and FIGS. 8 to 14 the stereoscopic projections have been printed aside and apart from each other for the sake of clarity of the representation; in a device according to the present invention the stereoscopic projections may be arranged (printed) to partially overlap each other, or alternatively, may be arranged (printed) aside each other; for devices useful as security elements, the stereoscopic projections are preferably arranged to partially overlap each other.

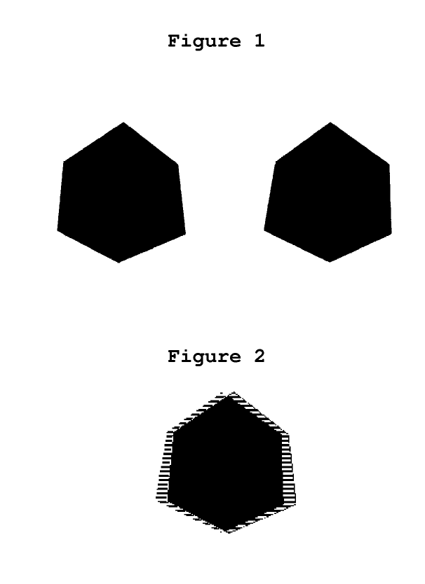

FIG. 6 illustrates an example of the present invention. FIG. 6 shows a pair of stereoscopic projections of the cube of FIG. 1 subdivided into 3 building blocks. The pair of stereoscopic projections are printed aside each other. When FIG. 6 is printed with LHLC and RHLC ink layers, an observer using appropriate viewing equipment comprising circularly polarizing filters will observe from a distance providing an appropriate parallax of the two projections a 3-D representation of the cube.

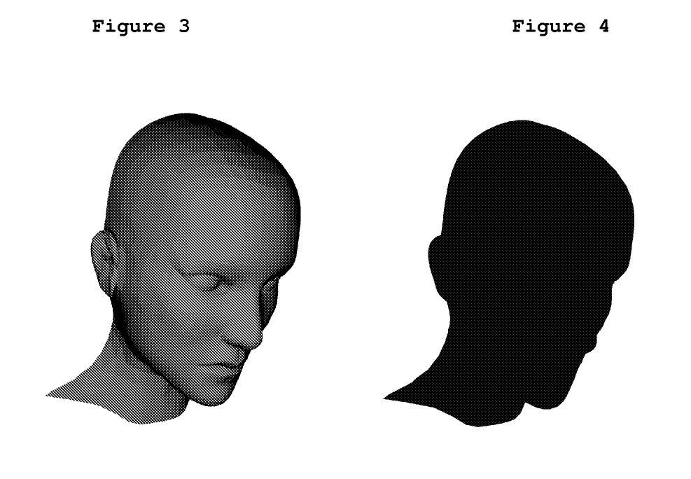

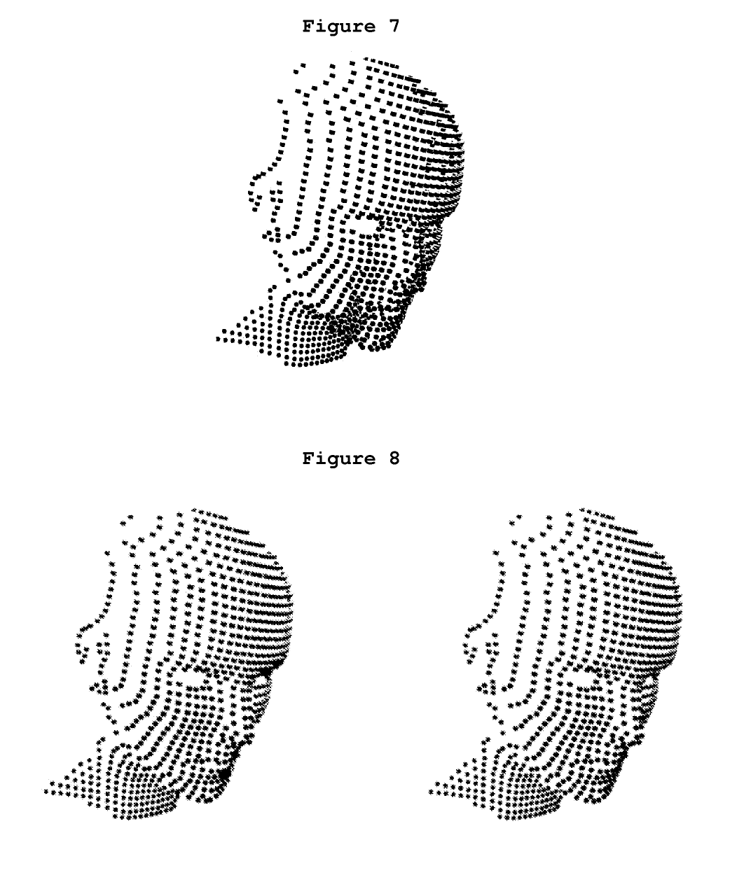

The image of FIG. 7 illustrates another example of the present invention. FIG. 7 shows the human head according to FIG. 3 which is, however, now subdivided into a plurality of building blocks, here dots. The image of FIG. 7 is “cleaned” to remove the building blocks that belong to the face of the human head located on the back side relative to the observer's position and are thus hidden to the observer from his viewing position. The cleaning process improves the 3D-effect by avoiding any occlusions of building blocks. This “cleaning step” can be omitted if the division into building blocks is done by applying an appropriate set of building blocks onto the surface of the objects seen by the observer from his viewing angle.

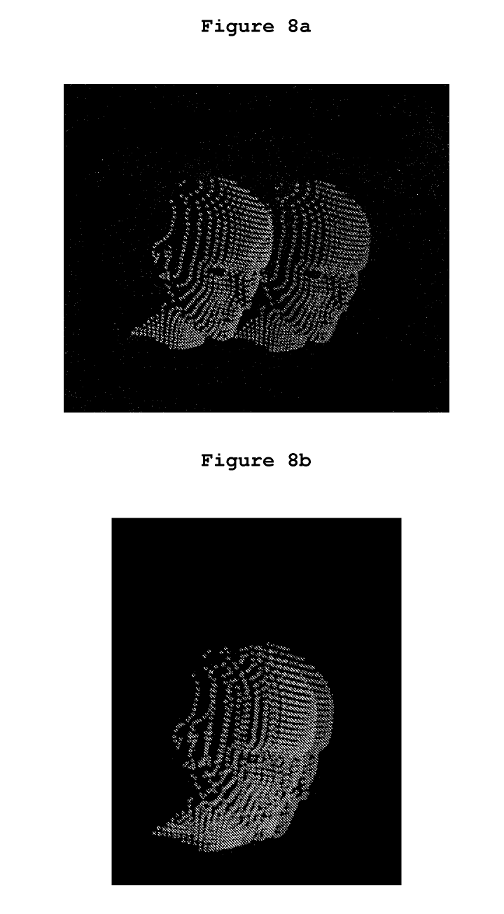

FIG. 8 shows a pair of stereoscopic projections of the subdivided graphical object produced by shooting two images of FIG. 7 from two different positions. The pair of stereoscopic projections are printed aside each other.

FIG. 8a and FIG. 8b show pictures of some devices according to the present invention based on a pair of stereoscopic projections of FIG. 8. In FIG. 8a, the stereoscopic projections slightly overlap each other, while in FIG. 8b the stereoscopic projections are printed such as to strongly overlap each other. An observer looking at FIG. 8a and using appropriate viewing equipment comprising circularly polarizing filters will observe, from a distance providing an appropriate parallax of the two projections, a 3-D representation of the human head. The 3-D effect is still more pronounced with FIG. 8b due to the stronger overlapping of the stereoscopic projections; FIG. 8b may also be observed from a shorter distance as the appropriate parallax is obtained at a shorter distance with FIG. 8b than with FIG. 8a.

The circularly polarizing liquid crystals pigments (referred to as the “LHLC and the RHLC pigments”) suitable for the present invention are known in the art, e.g. LC pigments commercialized under the trade name Helicone® from LCP Technology GmbH. LC pigments technology and their use in coatings and inks have been disclosed e.g. in EP 1 213 338 A1, EP 1 046 692 A1 or EP 0 601 483 A1, the entire disclosures of which are incorporated by reference herein. The cholesteric liquid crystals materials suitable for the present invention are known in the art and have been disclosed e.g. in U.S. Pat. No. 6,410,130, the entire disclosure of which is incorporated by reference herein.

The LHLC and RHLC pigments can be incorporated into conventional ink compositions according to the printing method selected to print the device of the present invention. Examples of suitable formulations may be found e.g. in The Printing Ink Manual, Ed R. H. Leach, R. J. Pierce, 5^{th} Edition, the entire disclosure of which is incorporated by reference herein.

Compositions comprising LC pigments suitable for use in the present invention have been disclosed e.g. in EP 0 597 986 A1 and WO 2003/020 835 A1, the entire disclosures of which are incorporated by reference herein.

Preferably, the ink compositions used for the present invention do not comprise any pigments other than LC pigments.

Examples of typical formulations comprising LC pigments for use in the present invention include: formulations for printing by flexography with a water-based ink:

| Component | weight-% |
|---|---|
| LHLC or RHLC Pigment | 10-30 |
| Acrylic/Alkyl resin binder | 50-70 |
| Polyethylene wax compound | 2-6 |
| Water | 10-20 |
| Silicone anti-foam | 0.1-0.5 |

formulations for printing by flexography with a solvent-based ink:

| Component | weight-% |
|---|---|
| LHLC or RHLC Pigment | 10-30 |
| Maleic resin varnish | 10-25 |
| Nitrocellulose varnish | 30-50 |
| Wax compound | 2-6 |
| Plasticizer | 1-5 |
| Ethanol | 5-15 |
| Isopropyl acetate | 5-10 |

formulations for printing by gravure:

| Component | weight-% |
|---|---|
| LHLC or RHLC Pigment | 10-30 |
| Nitrocellulose | 10-20 |
| Maleic resin | 2-6 |
| Wax dispersion | 2-6 |
| Dioctyl phthalate | 2-6 |
| Ethanol | 40-60 |
| Ethyl acetate | 2-8 |
| Glykol ether | 2-6 |

formulations for printing by screen printing:

| Component | weight-% |
|---|---|
| LHLC or RHLC Pigment | 8-25 |
| Ethyl cellulose | 10-20 |
| Dioctyl phthalate | 2-10 |
| Propylene glycol methyl ether | 20-30 |
| Dipropylene glycol methyl ether | 2-10 |
| Aromatic hydrocarbon (160-180° C.) | 20-40 |

formulations for printing by screen printing with a UV curable ink:

| Component | weight-% |
|---|---|
| LHLC or RHLC Pigment | 8-25 |
| Prepolymers | 20-35 |
| Monomers/oligomers | 30-50 |
| Photoinitiators | 5-10 |
| Other additives | 1-5 |

Compositions comprising LC substances suitable for use in the present invention have been disclosed e.g. in U.S. Pat. No. 6,410,130, the entire disclosure of which is incorporated by reference herein.

Suitable printing methods include silkscreen printing, flexo printing, heliogravure or inkjet printing.

Whereas in the LC pigments suitable for use in the present invention the liquid crystals are already aligned and polymerized (cured) in the cholesteric state, this is not the case for LC substances. After being applied by any of the above printing techniques, an alignment of the LC substances in the compositions has to be achieved before curing of the applied layers. According to the present invention, alignment of the LC substances may be achieved by applying the layers comprising the LC substances onto a pre-patterned substrate. The substrate then acts as an alignment layer for the liquid crystals in the applied layers. The pre-patterning of the substrate can occur, for example, through rubbing with a material such as velvet or with brushes or through a suitable exposure. Alignment of the LC substances occurs through an interaction with the pre-patterned substrate. Thereafter, the aligned LC layers can be cured as usual, preferably by UV-curing. This method of alignment of LC substances is known, e.g. from US 2011/0095518 A1, the entire disclosure of which is incorporated by reference herein.

Ink compositions suitable for use in the present invention may be cured as is known to the skilled person, e.g. by physical drying (evaporation of solvent), UV-curing, electron beam curing, heat-set, oxypolymerization, combinations of these methods, or by other curing mechanisms. Preferably UV-curable ink compositions are used for the present invention.

As used herein the device is useful as a security element or security feature for the protection of, for example, banknotes, documents of value, identity documents or generally any articles which require or at least benefit from authentication.

As used herein, the term “security element” designates an element on a banknote or any other security document for the purpose of determining its authenticity and protecting it against counterfeits.

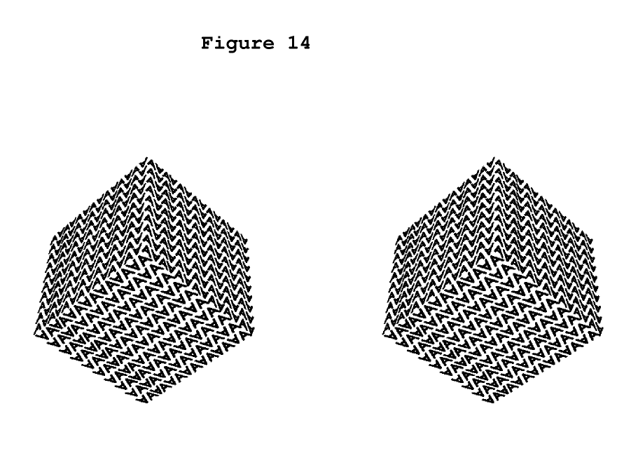

As used herein, the term “building blocks” refers to a group of geometrical figures which together form a graphical object, such as but not limited to, squares, rectangles, polygons, circles, dots, discs, ellipsoids, straight lines, curved lines, or any closed surfaces delimited by any sinusoidal lines. The term “separate building blocks” also includes letters, texts, logos, numbers or images. These building blocks may comprise void areas, such as for example the void area in the capital letter “A” (see FIG. 14). The building blocks forming the graphical object may be arranged in an equidistant alignment or in a random manner in such a way that the brain of an observer can combine the separate building blocks to one represented object. In other words, the distance between the separate building blocks has to be sufficiently wide to enable an observer to recognize the building blocks as being separate from one another. The space between two building blocks helps to define the edges of the subdivided object; the pair of stereoscopic images of every building block contributes to define the volume of the represented object or of the represented scene.

In each individual stereoscopic projection the building blocks are completely or partially separated from each other, depending on the positions of the camera relative to the object when creating the pair of images.

As used herein, the term “separate building blocks” refers to the fact that within the subdivided graphical object the building blocks forming the object are arranged in such a way that they are separately distinguishable, wherein within the stereoscopic projections the building blocks may partially overlap each other. As used herein, the term “separate building blocks” refers to the fact that the underlying background of the ink layers is apparent between the building blocks; the term “apparent” means visible to the naked eye of an observer.

The number of building blocks required to subdivide a graphical object depends on the size of the device, on the complexity of the represented object and on the achievable printing resolution.

For simple graphical objects division into two building blocks may suffice to give enough indication of the 3-D shape of the represented object; for more complex represented objects or scenes, a plurality of building blocks are necessary to give a good 3-D representation. The optimal number and position of the separate building blocks for a given graphical object may be determined by a skilled person by common routine.

The subdividing process is performed on the graphical object. The images captured by a camera to produce the pair of stereoscopic projections are produced after the division of the graphical object into separate building blocks.

An inverse sequence of steps (production of stereoscopic projections followed by division into building blocks) would lead to difficulties in keeping the coherence between the two stereoscopic projections and thus impede the production of a device with a 3-D effect.

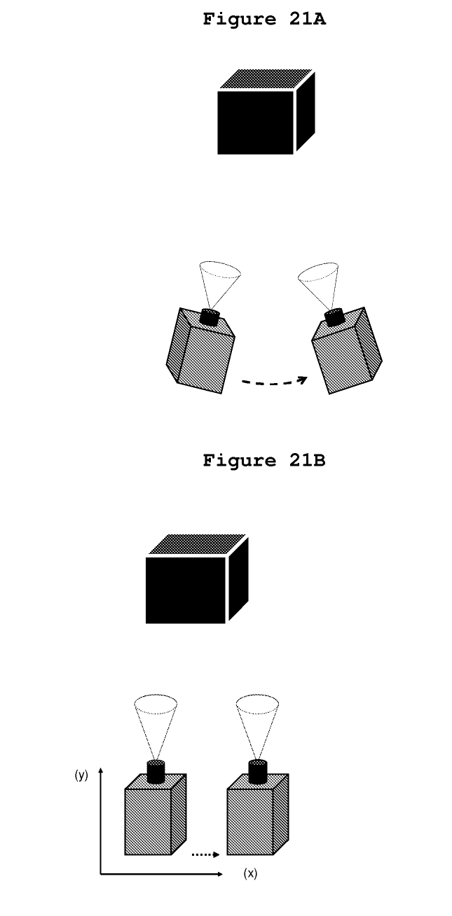

The two images captured by a camera to produce the pair of stereoscopic projections are typically obtained with a small change of the visual perspective of the image obtained by a small translation of the camera (see FIGS. 21a and 21b). The two shooting positions and angles of the camera should be selected such that most building blocks forming the graphical object remain distinguishable from the neighbouring building blocks; in such a configuration, two separate building blocks do not overlap each other, or two separate building blocks only partially overlap each other.

In FIGS. 5 to 14 embodiments according to the present invention are shown in which graphical objects of varying complexity are made up from an appropriate number of separate building blocks with varying form and complexity.

As used in the present invention, the term “graphical object” refers to a representation of a virtual object or to a representation of a real object.

Represented objects useful to create devices of the present invention comprise simple objects, e.g. a line or a 2-D drawing, or very complex objects, e.g. a view of a sculpture like e.g. a human head.

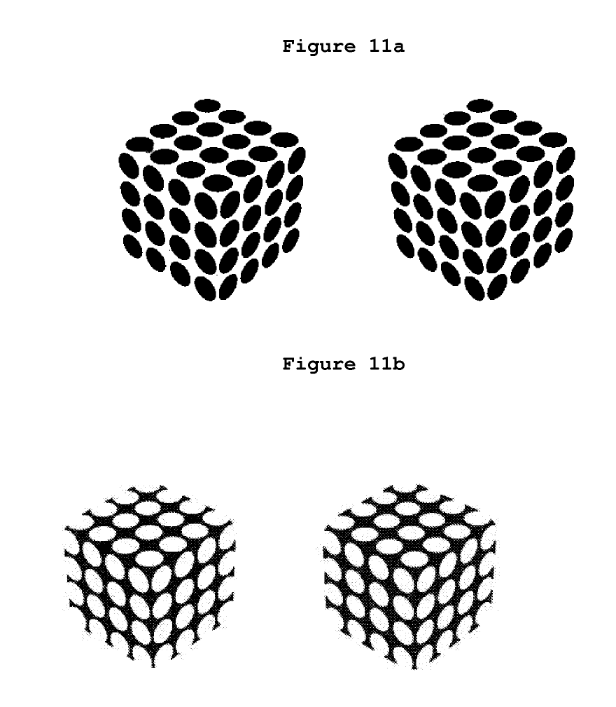

The graphical object of the present invention may be depicted as a positive image or as a negative image. When the object is depicted as a positive image, the building blocks composing the object, e.g. squares, rectangles, polygons, circles, dots, discs, ellipsoids, straight lines, curved lines, closed surfaces delimited by any sinusoidal lines, letters, texts, logos, numbers or images, are applied (printed) with the LC ink layers. When the object is depicted as a negative image, the separation areas between the building blocks are applied (printed) with the LC layers. FIG. 1la represents an example of a pair of stereoscopic projections of a positive image of a subdivided cube according to the present invention; FIG. 11b represents an example of a pair of stereoscopic projections of a negative image of a subdivided cube according to the present invention.

According to the present invention, the device having a three-dimensional appearance is obtained by applying two or at most four ink layers from printing inks comprising the above described cholesteric LC pigments or LC substances, preferably by applying two or at most four ink layers from printing inks comprising the above described cholesteric LC pigments.

Examples of suitable substrates for use in the present invention include paper, composite materials, and plastic (polymeric) substrates. For example, in the case of banknotes the substrate may be paper, a composite material or a polymeric material.

The porosity of the substrate printed with the device may influence the quality of the perceived 3-D effect. On porous or fibrous substrates a variation of the brilliance may appear in different zones of the pair of LC ink layers depending on the underlying layer in these zones. Such brilliance variations within the LC layers may lead to an impairment of the 3-D effect. To improve the optical quality of the LC ink layers and to prevent such variations of the brilliance, porous or fibrous substrates may be coated with a first coating layer, i.e., a primer layer. Such primer layers are known in the art and have been used for instance to improve the visual aspect of security elements based on magnetically oriented images (see WO 2010 058026, the entire disclosure of which is incorporated by reference herein).

As used herein, the term “underlying background” of the LHLC and RHLC ink layers refers to the surface onto which the LC ink layers are printed or placed.

The underlying background of the ink layers can be a non-transparent absorbing surface or a transparent surface.

As used herein, the terms “absorbing” or “light-absorbing” surface or background refer to a layer that absorbs at least a part of the visible spectrum of light, preferably to a surface of a dark color, most preferably to a black surface.

In the case of an absorbing background the background surface may, for example, consist of an underlying coating layer printed on the substrate or of the opaque substrate itself.

As used herein, the term “transparent” means providing for optical transparency at least in part of the visible spectrum (400-700 nm). Transparent substrates may be colored, entirely or in part, provided that there is transparency in at least a part of the visible spectrum, such as to allow an observer to see through the substrate.

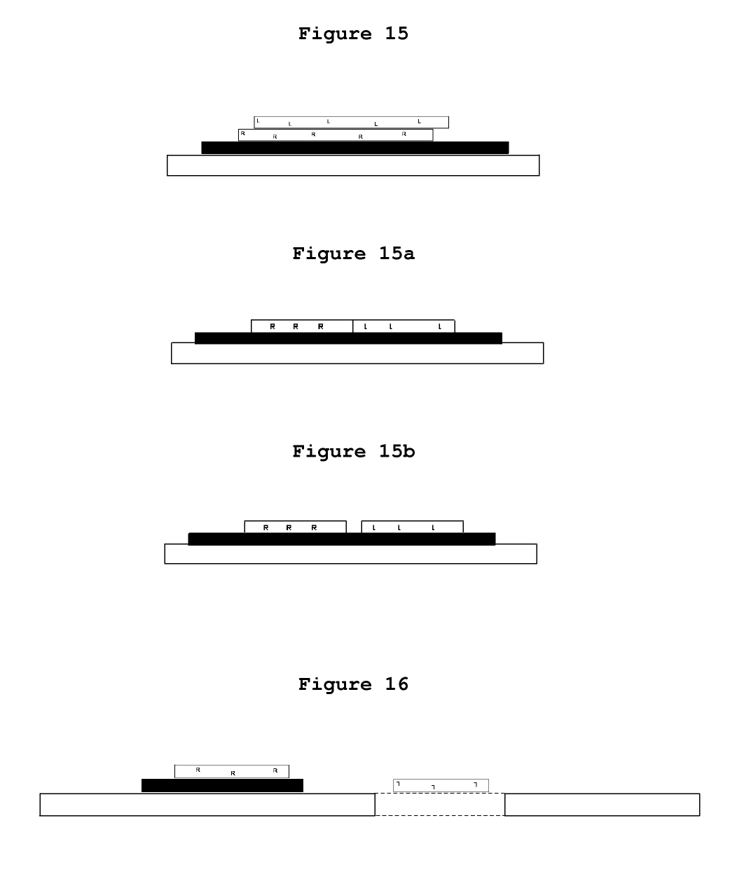

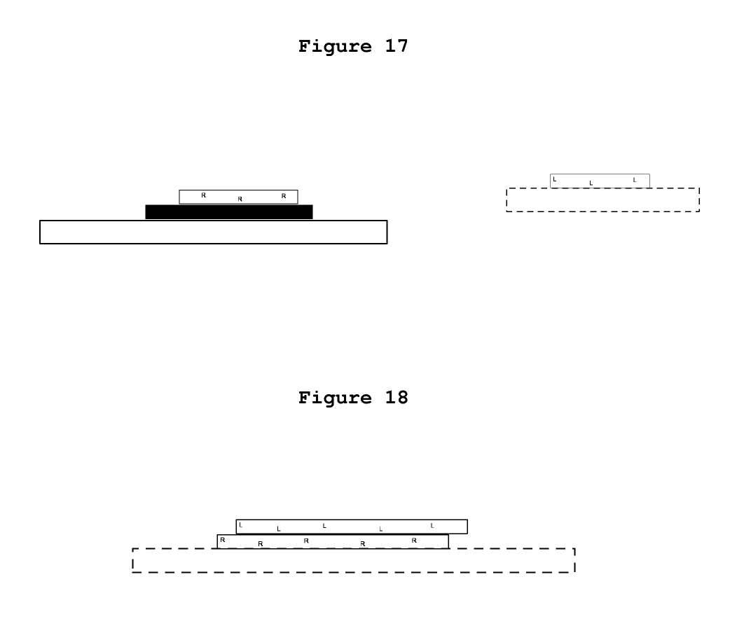

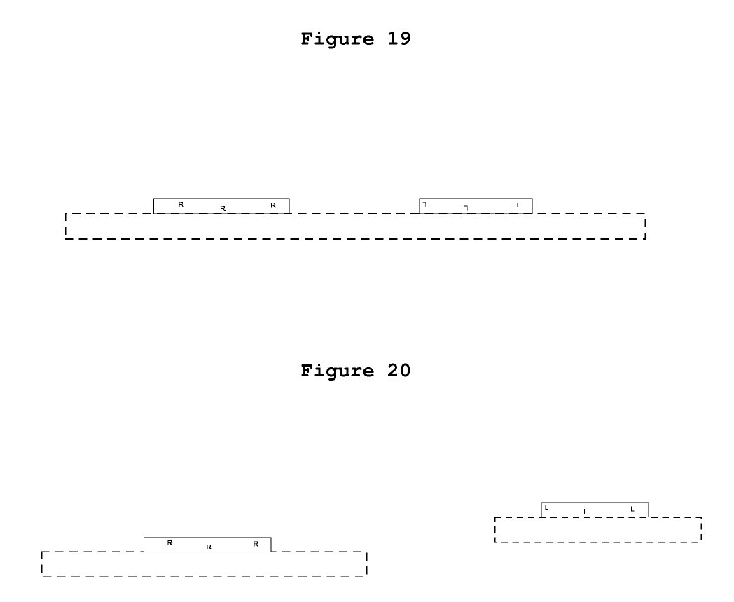

FIG. 15 to FIG. 20 illustrate examples of the different arrangement of the LHLC and RHLC image layers on absorbing or transparent substrates. In FIG. 15 to FIG. 20 the LHLC and RHLC image layers may be arranged as shown in the Figures or the layers may be swapped with each other.

When the device is arranged (printed) on a transparent background, either the LHLC image layer, the RHLC image layer or both the LHLC and the RHLC image layer may be arranged (printed) on a transparent surface.

When one of the LHLC and RHLC image layers is printed on a transparent surface and the other image layer is printed on an absorbing surface, the absorbing surface and the transparent surface may be part of the same substrate or may be part of two different substrates. When the transparent and the absorbing surface are part of a single substrate the two LHLC and RHLC ink layers may be observed as a 3-D device by folding the substrate such that the printed transparent surface is laid on top of the printed absorbing surface.

As used herein, the term “superimposed” stereoscopic projections or “superimposed” LC image layers or “superimposed” LC ink layers means that the first and second LC ink layers corresponding to the first and second stereoscopic projections are printed on top of each other in a partially overlapping position. An entire absolute overlapping in register is prevented by the slight difference between the 2 stereoscopic projections.

As used herein, the term “not superimposed” stereoscopic projections or “not superimposed” LC image layers or “not superimposed” LC ink layers means that the first and the second stereoscopic projections are printed aside each other in a contiguous or a non-contiguous position, with a distance between the projections of a few centimetres, preferably about 0-5 cm, more preferably about 0-3 cm, and most preferably about 0-1 cm.

As used herein, the term “superimposable stereoscopic projections or “superimposable” LC image layers or “superimposable” LC ink layers means that the first and second stereoscopic projections are applied (printed) on two different substrates, at least one of the two substrates being transparent, and can be laid upon each other; alternatively, the term “superimposable stereoscopic projections” or “superimposable LC image layers” or “superimposable” LC ink layers means that the first and the second stereoscopic projections are applied (printed) on two different zones of the same substrate, at least one of the two zones being transparent, and can be superimposed on the second zone by folding the substrate.

When both of the LHLC and RHLC image layers are applied (printed) on a transparent surface the image layers may be applied (printed) on the same transparent surface or the image layers may be applied (printed) on two different transparent surfaces comprised in the same or in two different substrates. The LHLC and RHLC image layers are superimposed either by folding the single substrate or by superposing both substrates so that the printed transparent layers are arranged on each other. When the LHLC and RHLC image layers are both applied (printed) on a transparent surface the superposed LC image layers must usually be placed on top of an (light) absorbing surface to let the two stereoscopic projections and the 3D-effect become visible for an observer using appropriate circularly polarizing filters.

It is known in the art that some axially oriented polymer materials may interfere with circularly polarized light; such polymer materials would impact the three-dimensional effect of the device when one of the stereoscopic projections of the graphical object is seen through the axially oriented polymer in the device. Therefore, when one of the LC ink layers within the device is seen through the transparent substrate said transparent substrate should not consist of axially oriented polymer materials.

Both LC layers must be completely enclosed within the boundaries of the underlying absorbing surface. In case one or both LC layers are positioned outside of the underlying absorbing surface, the 3-D perception may partially or completely fade away.

In order to see the three-dimensional effect of the device provided by the stereoscopic pair of images, for example the observer needs to use appropriate viewing equipment, in particular special glasses with circularly polarizing filters or lenses, as described in U.S. Pat. No. 5,457,554. The viewing equipment may preferably be eyeglasses comprising a pair of circularly polarizing filters or lenses, a left circularly polarizing filter or lens and a right circularly polarizing filter or lens, each filter or lens covering one of the eyes of the observer wearing these eyeglasses. The LHLC image layer is visible through the left circularly polarizing filter or lens and the RHLC image layer is visible through the right circularly polarizing filter or lens. Thus the observer using the viewing equipment sees each LC ink layer with only one eye: one of the stereoscopic projections represents the right-eye image and the second stereoscopic image represents the left-eye image. The image of the object with the 3-D effect is reconstructed by the observer's brain.

The method of the present invention provides means to provide a three-dimensional effect with only one single color at the same viewing angle LC material (one pair of LHLC and RHLC material) or with LC materials of 2 different colors at the same viewing angle.

When the LHLC and RHLC ink layers are of different color at the same viewing angle the color observed with the viewing equipment is the additive color of the two layers.

The present invention also provides to a process for producing a three-dimensional image. The method comprises

a) subdividing a graphical object into two separate building blocks or into a plurality of separate building blocks, said building blocks being identical or different, using computer software;
b) generating for each building block a left-eye image and a right eye image corresponding to first and second stereoscopic projections of the subdivided graphical object;
c) transferring the said first and second stereoscopic projections to a printing plate or support, or to a pair of printing plates or supports, according to the printing method to be used for printing the LHLC and RHLC ink layers;
d) printing said first stereoscopic projection by using a first LHLC or RHLC ink composition;
e) optionally, curing said first ink composition;
f) printing said second stereoscopic projection by using a second RHLC or the LHLC ink composition, said second LC ink composition reflecting circularly polarized light of opposite direction from the first LC ink composition;
g) curing the not yet cured ink composition.

When the 2 stereoscopic views are printed aside each other with no overlapping of the two LC ink layers, step e) can be omitted: both LC layers may be cured simultaneously in step g).

For step a), the division of the graphical object into separate building blocks, various appropriate types of software may be used. For instance, the publicly available program Blender (free software under the GNU General Public Licence) can be used; other types of software, such as 3DMax, Cinema 4D, Softimage or any similar tool may be used to achieve the same or analogous results.

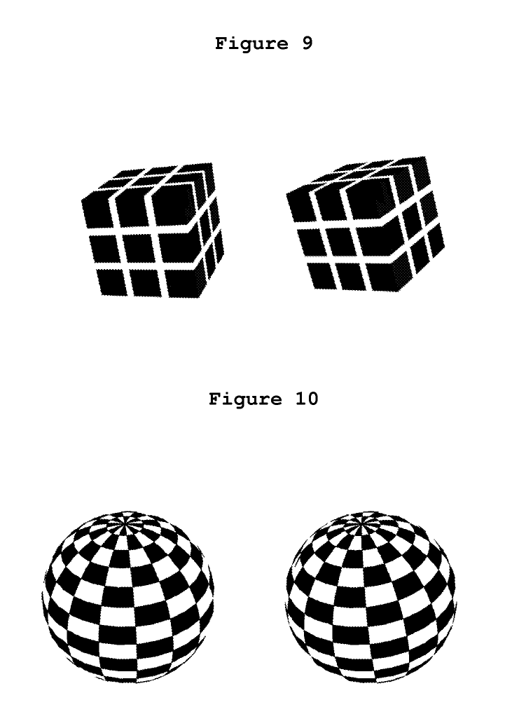

Step a), subdividing the graphical object into separate building blocks, is preferably achieved as follows using the Blender software:
i) selection of the graphical object to be subdivided by using the <Addition> function to add a “mesh”; as used in the software, the term mesh refers to a virtual object such as, e.g., a square, a cube, a sphere, a human head, or any other object that can be represented in the device of the present invention;
ii) using the <Edit Menu/Subdivide> function of the software, the graphical object is subdivided into building blocks. For instance, a cube is subdivided by subdividing each of its faces into a plurality of building blocks, e.g. squares. For instance FIG. 9 shows a pair of stereoscopic images of a cube created by subdividing each face into nine squares.

Alternatively, step a) above may be achieved as follows:
j) addition, by using the <Addition> function of the Blender software, of a “mesh” such as, e.g., a square, a dot, or a capital letter A;
jj) copying and multiple pasting of the mesh of step j) a plurality of building blocks are created and arranged in such a way as to represent a subdivided graphical object such as, e.g., a cube. For instance, FIG. 11a and FIG. 14 show pairs of stereoscopic projections of cubes that can be created by copy/paste of a disc or a capital letter A respectively.

In a further alternative, useful in particular for the subdivision of a graphical object representing a virtual or real object with an irregular uneven surface, step a), subdividing the graphical object into separate building blocks, may advantageously be achieved as follows using the Blender software:
k) creation by copy/paste of a network composed of a plurality of meshes (e.g. a plurality of squares or of cubes);
kk) by linear translation using the Mapping function of the software Blender, the meshes are stacked onto the surface of a virtual object serving as a mould, e.g. a human head; the virtual object is removed, leaving only the network of meshes with the shape of the virtual or real object.

The number of building blocks and the types of building blocks may be selected according to the desired effect. According to the complexity of the graphical object and to the number of building blocks, the subdividing of the object into building blocks (step a)) may comprise additionally a “cleaning process” of the building blocks: when the graphical object subdivision is done with software the subdivided graphical object may comprise building blocks pertaining to the back side (hidden side) of the represented virtual object which should not be visible to the observer from his viewing angle; occlusions of the back side building blocks through the front side building blocks occur; in order to improve the 3-dimensional effect of the device said building blocks from the back side may be removed in a cleaning process. For instance, in FIG. 7 building block occlusions are visible on the chin of the human head; after the cleaning process the contours of the chin are more precise (as seen in each stereoscopic projection in FIG. 8).

The same software used for the subdivision of the graphical object (Blender, 3DMax, Cinema 4D, Softimage or any similar tool) may also be used to create the stereoscopic images corresponding to the stereoscopic projections of the subdivided graphical object by using the virtual camera tool of these softwares. For instance, the Blender software may also be used to shoot the stereoscopic images of subdivided graphical objects with virtual cameras.

Genuine pictures resulting from shooting existing or virtual subdivided objects with a real camera may also be used to create the pair of images corresponding to the pair of stereoscopic projections.

The methods for step c), transfer of the stereoscopic projections to the appropriate printing plates or supports according to the printing method, depend on the selected printing technique. These methods are widely used in the printing industry and are described in reference handbooks, e.g. in Printing Technology, J M Adams and P. A. Dolin, Delmar Thomson Learning, 5^{th} Edition.

For instance, for printing the device by screen printing a stencil for each of the first and second stereoscopic projections may be produced by processes known in the art, e.g. by producing photographic stencils as described in e.g. Printing Technology, J M Adams and P. A. Dolin, Delmar Thomson Learning, 5^{th} Edition, page 302-312 (the entire disclosure of which is incorporated by reference herein):

1) each of the first and second stereoscopic projections is printed as a black-and-white positive image on a transparent overlay with a laser printer;
11) first and second mesh screens are coated with a photo-emulsion and dried in the dark;
111) each transparent overlay (corresponding to the first and second stereoscopic projections of the subdivided graphical object) is placed over an emulsion-coated screen and then exposed to UV-light;
1111) each screen is washed off thoroughly to remove the non-exposed emulsion leaving on each mesh screen a negative stencil image of a stereoscopic projection.

The first mesh screen with the first negative stencil is used to print the first image layer corresponding to the first stereoscopic projection, with the LHLC or alternatively with the RHLC ink composition; the second mesh screen with the second negative stencil is used to print the second image layer corresponding to the second stereoscopic projection, with the RHLC or alternatively the LHLC ink composition.

In steps e) and g) the LC ink compositions may be cured by physical drying (evaporation of solvents), UV-curing, e-beam curing, heat set, oxypolymerization, or any combinations thereof, most preferably by UV-curing.

When the ink compositions used to print the pair of stereoscopic images comprise cholesteric liquid crystal substances, the LC substances are aligned to form LC phases before the ink compositions are cured by physical drying (evaporation of solvents), UV-curing, e-beam curing, heat set, oxypolymerization, or any combinations thereof, most preferably by UV-curing.

The device according to the present invention may be printed by various printing methods such as silkscreen printing, flexo printing, heliogravure or inkjet printing; the LC layers are most preferably printed by silkscreen printing.

### EXAMPLES

In order to illustrate the process for the creation of subdivided graphical objects in accordance with the present invention examples were prepared using the publicly available program Blender (free software under the GNU General Public Licence) for the 3-D computer modelling of objects.

The Blender software was also used to shoot the images used to form the stereoscopic projections of the subdivided graphical object with virtual cameras.

### Comparative Example 1

### Pair of Mono-Color Stereoscopic Projections of a Non-Subdivided Cube (FIGS. 1 and 2)

By observing a mono-color representation of the pair of stereoscopic projections of a cube without shade gradients, reflections or shadows, an observer, using appropriate viewing equipment such as a pair of circularly polarizing filters, could not interpret the represented object as a 3-D object (even if the projections are printed with LHLC and RHLC layers). The object looked like a flat irregular polygon (FIG. 1).

When the stereoscopic projections of FIG. 1 were superimposed (FIG. 2), an observer still could not observe the 3-D effect even when using an appropriate viewing device such as a pair of appropriate circularly polarizing filters.

### Example 1

### Pair of Mono-Color Stereoscopic Projections of a Subdivided Cube (FIG. 6)

A graphical object, a representation of a virtual cube, was subdivided into separate building blocks according to the method of the present invention. A pair of stereoscopic projections of the subdivided cube was generated by shooting a pair of images from two different positions. When the pair of stereoscopic projections of the subdivided graphical object was printed with LHLC and RHLC layers an observer using appropriate viewing equipment such as a pair of appropriate circularly polarizing filters observing the device from a distance providing an appropriate parallax of the two projections observed a 3-D shape.

FIG. 5 was obtained by printing the pair of stereoscopic projections of FIG. 6 such that they partially overlapped each other.

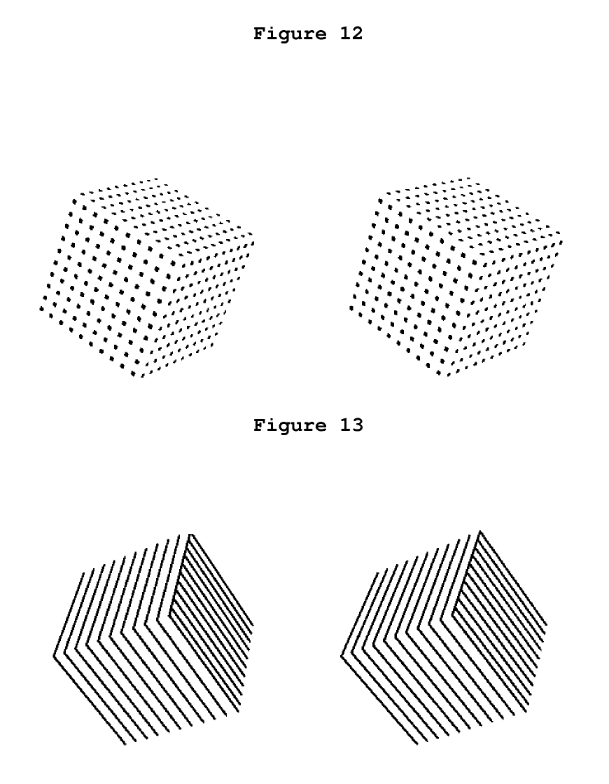

In a similar way, FIGS. 9, 11, 12, 13, 14 represent mono-color stereoscopic projections of a cube with different types of building blocks. (The building blocks are cubes in FIG. 9, in FIG. 11a discs as a positive image, in FIG. 11b discs as a negative image, in FIG. 12 dots, in FIG. 13 lines, in FIG. 14 capital letters A).

### Example 2

### Pair of Mono-Color Stereoscopic Projections of a Subdivided Cube Partially Overlapping Each Other (FIG. 5)

A graphical object, a representation of a virtual cube, was subdivided into separate building blocks according to the method of the present invention. A pair of stereoscopic projections of the subdivided cube was generated by shooting a pair of images from two different positions. The pair of stereoscopic projections of the subdivided graphical object was printed with LHLC and RHLC layers such as to partially overlap each other. An observer using appropriate viewing equipment such as a pair of appropriate circularly polarizing filters observed a 3-D shape even from a very short distance such as an arm's length or an even shorter distance.

### Example 3

### Pair of Mono-Color Stereoscopic Projections of a Subdivided Sphere (FIG. 10)

A graphical object, a representation of a virtual sphere, was subdivided into separate building blocks according to the method of the present invention. Here, good results were obtained by separating the sphere into building blocks along its latitudes and longitudes.

### Comparative Example 2

A virtual 3-D object (a virtual human head) was modelized with the Blender software and printed using inks of different grade of grey color (shadow areas) (FIG. 3). The 3-D shape of the object was recognizable.

The image of FIG. 3 was printed with a mono-color ink (FIG. 4). The 3-D shape was not recognizable anymore.

### Example 4

The image of FIG. 3 was subdivided into a plurality of building blocks, in this example dots, according to the method of the present invention (FIG. 7) using the program Blender. The 3-D shape of the object was recognizable.

A “cleaning” of the image of FIG. 7 was performed by removing the building blocks (dots) that should not be visible from the chosen viewing angle. The cleaning process improved the 3D-effect by avoiding any occlusions of building blocks.

A pair of images of FIG. 7 was created using the virtual cameras of the software Blender affording the pair of stereoscopic projections (FIG. 8).

The pair of stereoscopic projections of FIG. 8 was used to produce a pair of stencils by the photographic stencil method:

i) the stereoscopic projections were printed as a black-and-white positive image on a transparent overlay with a laser printer;
ii) two mesh screens were coated with a photo-emulsion and dried in the dark;
iii) each transparent overlay (corresponding to the left-eye and to the right-eye projections of the subdivided object) was placed over an emulsion-coated screen and then exposed to UV-light;
iv) each screen was washed off thoroughly to remove the non-exposed emulsion leaving on each mesh screen a negative stencil of the respective stereoscopic projection.
Preparation of ink compositions comprising the LC pigments:

| Component | Parts by weight (g) |
|---|---|
| Ebecryl 438 | 30 |
| TPGDA | 46 |
| Ebecryl 438 | 30 |
| PI | 5 |
| Aerosil 200 | 2 |
| LHLC or RHLC Pigment | 17 |

In the composition above, PI represents a blend of photoinitiators with the following composition:

| | | |
|---|---|---|
| PI Blend | Component | Weight % |

| | |
|---|---|
| ITX | 13 |
| EPD | 14 |
| BZP | 13 |
| BDK | 40 |
| IRGACURE 369 | 20 |

ITX: Isopropyl thioxanthone;
EPD: Ethyl-4-dimethylamino benzoate;
BZP: 4-Phenyl benzophenone;
BDK: Benzyl dimethyl ketal

a) The pair of stereoscopic images of FIG. 8 was printed on a black-coated Chromolux cardboard using the LHLC ink composition with one of the mesh-screens and the RHLC ink composition with the second mesh-screen aside each other. The ink layers were cured by UV irradiation.

FIG. 8a shows a picture of the device obtained by this method.

b) Alternatively, one of the stereoscopic projections of FIG. 8 was printed on a black-coated Chromolux cardboard using the LHLC containing ink composition with one of the mesh screens. The ink layer was dried by UV-curing.

The second stereoscopic projection of FIG. 8 was printed with the RHLC containing ink composition with the second mesh-screen such as to partially overlap the first stereoscopic projection. Said second ink layer was cured by UV-irradiation.

FIG. 8b shows a picture of the device obtained by this method.

An observer viewing the resulting devices (FIG. 8a and FIG. 8b) and using an appropriate viewing device such as a pair of circularly polarizing filters recognized the 3-D shape of the object when observing the image formed by the pair of stereoscopic projections from a distance providing an appropriate parallax.

For FIG. 8b the best 3-D effect was observable from a very short distance, e.g. an arm's length distance or an even shorter distance; FIG. 8a was best observed from a larger distance than FIG. 8b.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An authentication device, wherein the device comprises arranged on one or more substrates first and second ink layers which together and when observed with appropriate viewing equipment represent a graphical object exhibiting a three-dimensional appearance, one of said ink layers being a left-handed circularly polarizing coating or comprising a left-handed circularly polarizing pigment and the other one of said ink layers being a right-handed circularly polarizing coating or comprising right-handed circularly polarizing pigment, wherein said first and second ink layers represent a first image and a second image of a pair of stereoscopic projections of said graphical object, and wherein said graphical object is composed of separate building blocks and within each of the stereoscopic projections an underlying background of said ink layers is apparent between the building blocks.

2. The device of claim 1, wherein said first and second ink layers are at least partially superimposed on each other.

3. The device of claim 1, wherein said first and second ink layers are arranged on the same or on a different substrate and are superimposable on each other.

4. The device of claim 1, wherein said first and second ink layers are arranged aside each other on the same substrate.

5. The device of claim 1, wherein when viewed under the same viewing angle the first and second ink layers exhibit the same color.

6. The device of claim 1, wherein when viewed under the same viewing angle the first and second ink layers exhibit different colors.

7. The device of claim 1, wherein said circularly polarizing pigments comprise chiral optically variable liquid crystal pigments.

8. The device of claim 1, wherein said circularly polarizing coatings comprise chiral optically variable liquid crystal substances.

9. The device of claim 1, wherein the stereoscopic projections of the graphical object comprise only those building blocks which belong to the surface of the graphical object that is visible from an observer's viewing angle.

10. The device of claim 1, wherein said building blocks are selected from one or more of squares, rectangles, polygons, circles, dots, discs, ellipsoids, straight or curved lines, closed surfaces delimited by sinusoidal lines, letters, texts, logos, numbers, and images.

11. The device of claim 1, wherein at least some of said building blocks comprise void areas.

12. The device of claim 11, wherein at least some of said building blocks do not comprise void areas.

13. The device of claim 1, wherein said graphical object is composed of identical building blocks.

14. The device of claim 1, wherein said graphical object is composed of two or more different building blocks.

15. The device of claim 1, wherein at least one of said ink layers is provided on a substrate having a light absorbing surface.

16. The device of claim 1, wherein at least one of said ink layers is provided on a transparent substrate.

17. The device of claim 1, wherein one of said first and second ink layers is provided on a substrate having a light absorbing surface and the other one of said ink layers is provided on a transparent substrate.

18. The device of claim 1, wherein at least one of said ink layers is UV-curable.

19. A method for producing the device of claim 1, wherein said method comprises applying onto at least one substrate a first ink composition and a second ink composition to form first and second ink layers, one of said ink compositions comprising left-handed circularly polarizing cholesteric liquid crystal pigments and the other one of said ink compositions comprising right-handed circularly polarizing cholesteric liquid crystal pigments.

20. The method of claim 19, wherein at least one of the compositions is applied by a printing method.

21. The method of claim 20, wherein the printing method comprises one or more of silkscreen printing, flexo printing, heliogravure, and inkjet printing.

22. The method of claim 21, wherein the printing method comprises silkscreen printing.

23. The method of claim 19, wherein when viewed under the same angle the left-handed circularly polarizing cholesteric liquid crystal pigments and the right-handed circularly polarizing cholesteric liquid crystal pigments exhibit the same color.

24. The method of claim 19, wherein when viewed under the same angle the left-handed circularly polarizing cholesteric liquid crystal pigments and the right-handed circularly polarizing cholesteric liquid crystal pigments exhibit different colors.

25. The method of claim 19, wherein the ink compositions are applied successively and the first ink composition is at least partially cured before applying the second ink composition.

26. The method of claim 19, wherein at least one of the ink compositions is cured by UV radiation.

27. A method for producing the device of claim 1, wherein the method comprises:
a) applying a first ink composition and a second ink composition onto at least one pre-patterned substrate to form first and second ink layers, one of said ink compositions comprising a left-handed circularly polarizing cholesteric liquid crystal substance and the other one of said ink compositions comprising a right-handed circularly polarizing cholesteric liquid crystal substance;
b) aligning the ink layers of (a) by interaction with the pre-patterned substrate to form aligned layers; and
c) curing the aligned layers.

28. The method of claim 27, wherein at least one of the compositions is applied by a printing method.

29. The method of claim 28, wherein the printing method comprises one or more of silkscreen printing, flexo printing, heliogravure, and inkjet printing.

30. The method of claim 29, wherein the printing method comprises silkscreen printing.

31. The method of claim 27, wherein when viewed under the same angle the left-handed circularly polarizing cholesteric liquid crystal substance and the right-handed circularly polarizing cholesteric liquid crystal substance exhibit the same color.

32. The method of claim 27, wherein when viewed under the same angle the left-handed circularly polarizing cholesteric liquid crystal substance and the right-handed circularly polarizing cholesteric liquid crystal substance exhibit different colors.

33. The method of claim 27, wherein the ink compositions are applied successively and the first ink composition is at least partially cured before applying the second ink composition.

34. The method of claim 27, wherein at least one of the ink compositions is cured by UV radiation.

35. A method for producing a device representing a graphical object exhibiting a three-dimensional appearance when observed with appropriate viewing equipment, wherein the method comprises
subdividing said graphical object into at least two separate building blocks;
generating first and second stereoscopic projections of the subdivided graphical object on a printing plane.

36. An authentication system, wherein the system comprises a device of claim 1 and viewing equipment which allows to observe a three-dimensional representation of a graphical object provided by the device.

37. The system of claim 36, wherein the viewing equipment comprises glasses comprising a left circularly polarizing filter and a right circularly polarizing filter for two lenses, each lens covering one eye of an observer wearing those glasses.

38. A commercial good or security document which comprises the device of claim 1.

39. The commercial good or security document of claim 38 which is at least one of a banknote, a document of value, a credit card, an identification document or card, a transportation ticket or card, a tax banderol, and a product label.

40. A method of protecting a commercial good or security document against counterfeiting, wherein the method comprises providing the commercial good or security document with a device of claim 1.

41. The method of claim 40, wherein the commercial good or security document is at least one of a banknote, a document of value, a credit card, an identification document or card, a transportation ticket or card, a tax banderol, and a product label.
